(19) United States
(12) Patent Application Publication
(10) Pub. No.: US 2014/0167690 A1
(43) Pub. Date: Jun. 19, 2014

(54) WIRELESS CHARGING BATTERY MODULE AND CHARGING STRUCTURE OF THE SAME

(71) Applicant: Tsuan-Yuan TING, Tainan (TW)

(72) Inventors: Tsuan Yuan Ting, New Taipei City (TW); Te-Hsien Ting, New Taipei City (TW)

(21) Appl. No.: 14/235,690

(22) PCT Filed: Jul. 17, 2012
(86) PCT No.: PCT/CN2012/000963

§ 371 Date: Jan. 28, 2014

(30) Foreign Application Priority Data
Aug. 1, 2011 (CN) 201120276069.9

(51) Int. Cl. H02J 7/02

(52) U.S. Cl. CPC H02J 7/025
USPC 320/108

(57) ABSTRACT

A wireless charging battery module and a charging structure of the same are revealed. The battery module includes a battery and a charging unit while the charging unit having a looped wire and a charging circuit. The charging unit is electrically connected to the battery. The charging structure consists of the battery module and a wireless charger. The wireless charger includes a charger board and the charger board is arranged with another looped wire. The looped wire is corresponding to the looped wire of the charging unit. Electromagnetic induction between the looped wire of the charging unit and the looped wire of the wireless charger occurs so that power stored in the wireless charger is output to the battery module in a wireless manner and the battery is charged by the charging circuit. The battery of the battery module is also charged wirelessly.

### FIELDS OF THE INVENTION

The present invention relates to a wireless charging battery module and a charging structure of the same, especially to a wireless charging battery module and a charging structure of the same in which electromagnetic induction between the battery module and a wireless charger occurs so that the battery module is charged by power stored in the wireless charger in a wireless way.

### DESCRIPTIONS OF RELATED ART

Electronics such as mobile phones, digital cameras, personal digital assistants, notebooks and other portable devices need connection to a power source once the power is running out. For normal operation and power supply, users connect the electronics to a socket by transmission lines and plugs. Thus the electronics are connected to the electricity network and receiving the power required. Home appliances such as vacuum cleaners are also connected to sockets by transmission lines and plugs for power supply.

However, the above charging way by using wires such as transmission lines and plugs is not as convenient as the wireless way. Users may find it inconvenient to carry the transmission line and perform the charging ^{process.}

Although there are wireless chargers that charge mobile phones, digital cameras, and personal digital assistants in a wireless manner available now, the battery is unable to be charged directly by the wireless charger in a wireless way.

Thus there is room for improvement and a need to provide a novel wireless charging structure.

### SUMMARY OF THE INVENTION

Therefore it is a primary object of the present invention to provide a wireless charging battery module and a charging structure of the same that overcome shortcomings of techniques available now mentioned above and perform charging in a wireless way. A battery of a battery module can also be charged in a wireless way.

In order to achieve the above object, a wireless charging battery module of the present invention includes a battery and a charging unit The charging unit consists of a looped wire and a charging circuit while the charging unit is electrically connected to the battery. Electromagnetic induction between a wireless charger and the looped wire occurs so that power is output to the battery module in a wireless way and the battery is charged by the charging circuit.

The wireless charging battery module is further arranged with a surface portion that covers both the charging unit and the battery for protection.

A charging structure of the battery module according to the present invention consists of a battery module and a wireless charger. The battery module is composed of a battery and a charging unit. The charging unit is formed by a looped wire and a charging circuit while the charging unit is electrically connected to the battery. The wireless charger includes a charger board and the charger board is arranged with a looped wire corresponding to the looped wire of the charging unit. Electromagnetic induction between the looped wire of the charging unit and the looped wire of the wireless charger occurs so that power stored in the wireless charger is output to the battery module in a wireless manner and the battery is charged by the charging circuit.

The wireless charger is arranged with a power connector port.

The power connector port is connected to a solar panel.

The wireless charger further includes a rechargeable battery for charging and power storage. The rechargeable battery is electrically connected to the charger board.

The wireless charger is further arranged with a lateral portion.

Besides the battery module, the charging structure that charges the battery module in a wireless manner according to the present invention further includes a wireless charger. The wireless charger consists of a charger board that is arranged with another looped wire. The looped wire is corresponding to the looped wire of the charging unit. Thus electromagnetic induction between the battery module and the wireless charger occurs. Therefore power stored in the wireless charger is output to the battery module in a wireless manner and the battery is charged by the charging circuit.

The present invention is charged in a wireless manner and the battery of the battery module is also charged wirelessly.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing an explosive view of a battery module of an embodiment according to the present invention;

FIG. 2 is a perspective view of a battery module of an embodiment according to the present invention;

FIG. 3 is a schematic drawing showing a battery module set on a wireless charger for wireless charging of an embodiment according to the present invention;

FIG. 4 is a cross sectional view of a battery module set on a wireless charger during wireless charging of an embodiment according to the present invention;

FIG. 5 is a perspective view showing a wireless charger of an embodiment connected to a solar panel according to the present invention;

FIG. 6 is a perspective view showing a wireless charger of an embodiment connected to a solar panel for wireless charging of a battery module according to the present invention;

FIG. 7 is a schematic drawing showing an explosive view of a charger board and a rechargeable battery of an embodiment according to the present invention;

FIG. 8 is a perspective view of a wireless charger of an embodiment according to the present invention;

FIG. 9 is a schematic drawing showing a battery module arranged at a side surface of a wireless charger during wireless charging of an embodiment according to the present invention.

### DETAILED DESCRIPTION OF THE PREFERRED EMBODIMENT

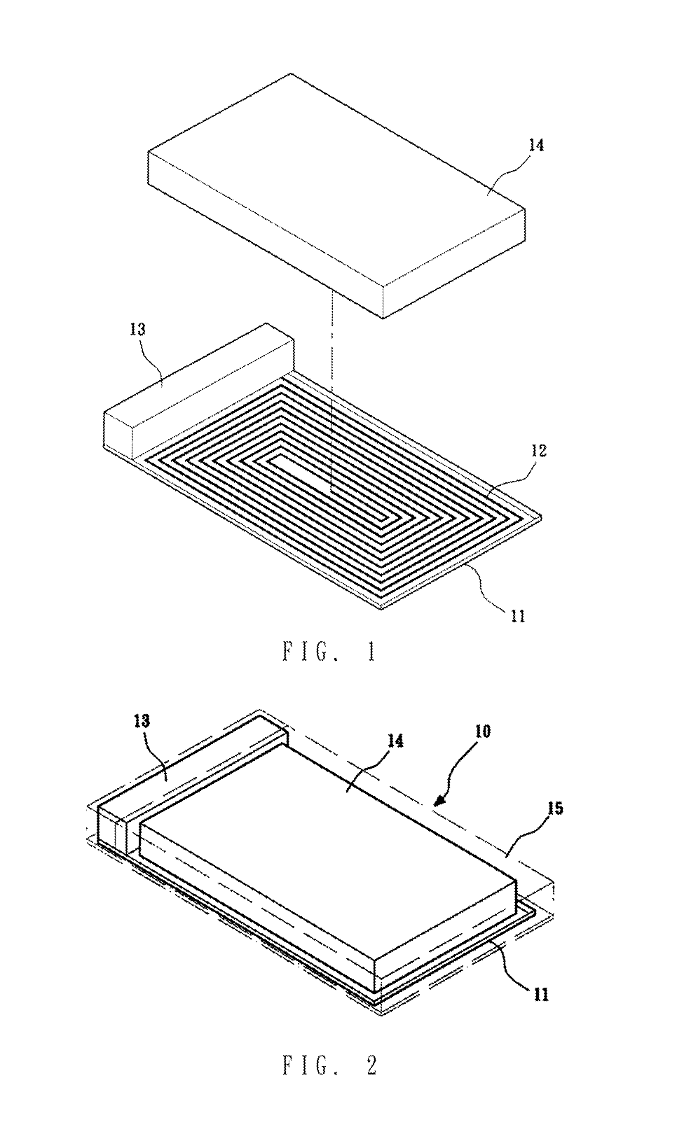

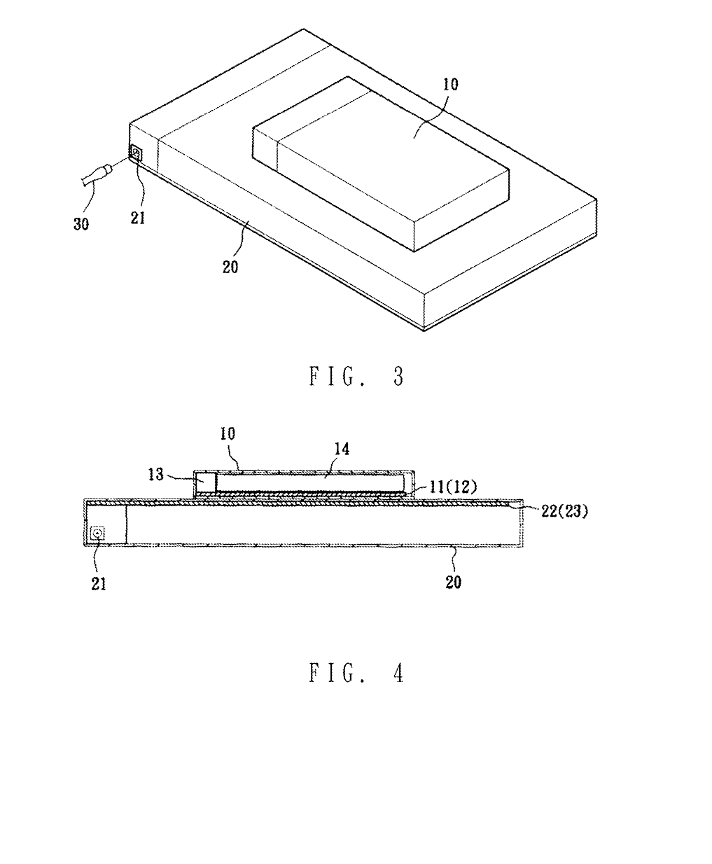

Refer to FIG. 1, FIG. 2 and FIG. 3, a wireless charging battery module 10 of the present invention includes a charging unit 11 and a battery 14. Besides the battery module 10, a charging structure of the battery module 10 consists of a wireless charger 20 stored with power. While in use, the battery module 10 is set on a top surface of the wireless charger 20. Thus electromagnetic induction between the battery module 10 and the wireless charger 20 occurs and the battery 14 of the battery module 10 is charged by the wireless charger 20 in a wireless way.

As shown in FIG. 1 and FIG. 2, the charging unit 11 of the battery module 10 can be a circuit board in which all elements are integrated and are used for wireless power receiving, power control and power charging of the battery 14. The charging unit 11 is disposed with a looped wire 12 and a charging circuit 13. The looped wire 12 is for receiving power while the charging circuit 13 is for stabilizing voltage signal. If a power loss occurs, the battery 14 starts being charged. Once the battery 14 is charged to full capacity, the charging circuit 13 controls the battery 14 and prevents the battery 14 from being overcharged and damaged.

The battery 14 is a rechargeable battery (storage battery) and is electrically connected to the charging unit 11.

The battery module 10 is further arranged with a surface portion 15 that covers both the charging unit ii and the battery 14 for protection. The surface portion 15 can be mounted with an opening so as to take out or put in the battery 14 for replacement.

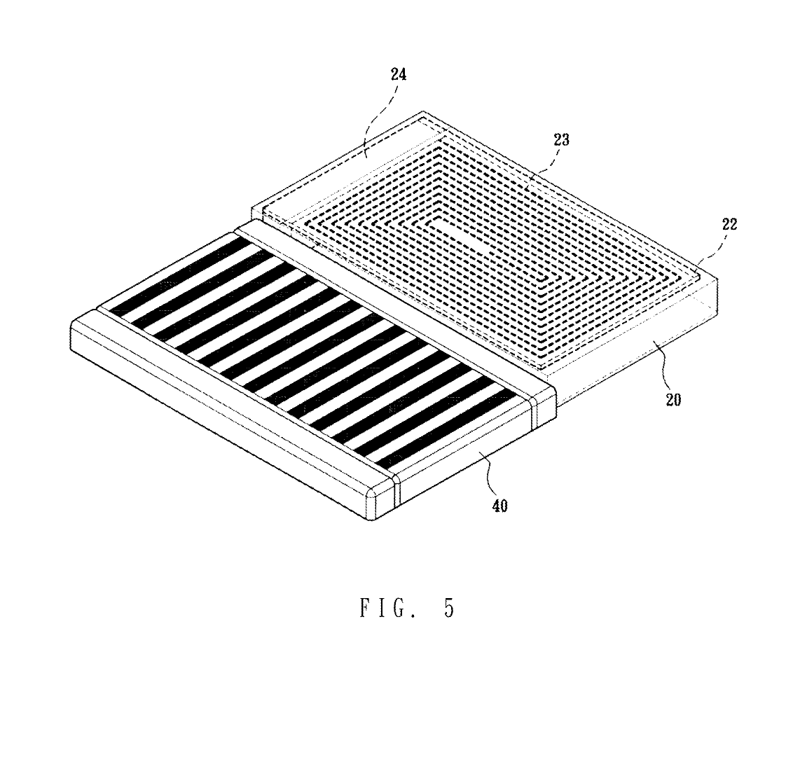

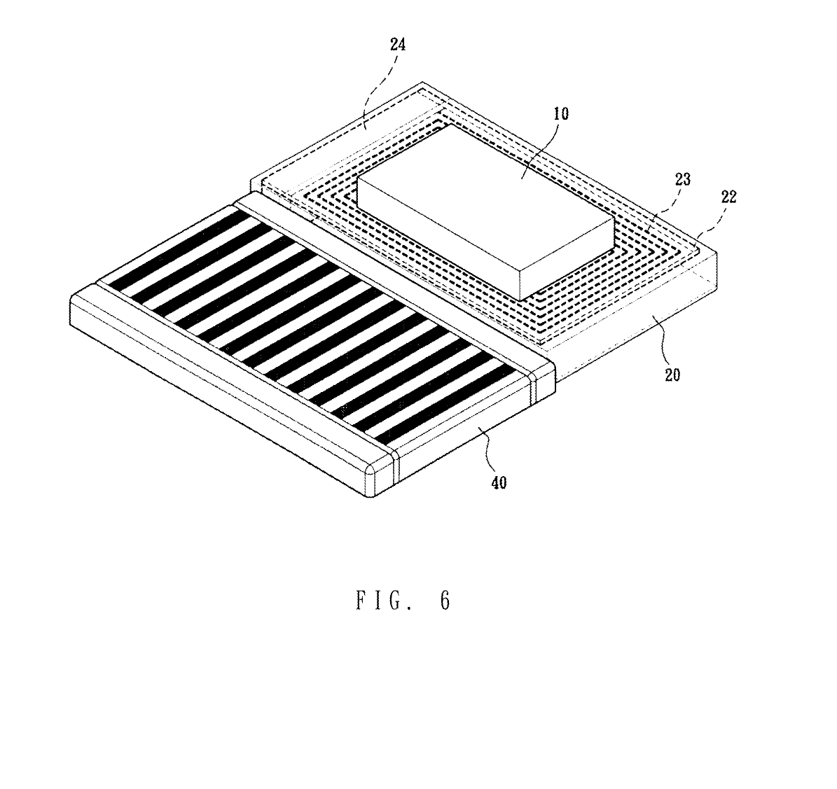

Refer FIG. 3, FIG. 4 and FIG. 5, a power connector port 21 is disposed on one side of the wireless charger 20 and is for receiving the electricity network power from a transmission line 30. Then the power is stored in the wireless charger 20. The wireless charger 20 includes a charger board 22 that is arranged with another looped wire and a power storage circuit 24. The looped wire 23 is corresponding to the looped wire 12 of the charging unit 11 while the power storage circuit 24 is for stabilizing voltage signals so as to charge the wireless charger 20 properly. if a power loss occurs, the wireless charger 20 starts being charged. Once the wireless charger 20 is charged to full capacity, the power storage circuit 24 controls the wireless charger 20 and prevents the wireless charger 20 from being overcharged.

Refer to FIG. 3 and FIG. 4, the battery module 10 of the present invention is arranged over the wireless charger 20 while in use. Electromagnetic induction between the looped wire 12 of the charging unit 11 and the looped wire 23 of the wireless charger 20 occurs so that power stored in the wireless charger 20 is output to the battery module 10 in a wireless manner and the battery 14 is charged by the charging circuit 13.

As shown in FIG. 5 and FIG. 6, the power connector port 21 of the wireless charger 20 can also be assembled with and connected to a solar panel 40 that collects solar energy, converts light energy to power and stores the power by the power storage circuit 24. Thereby the battery module 10 is wirelessly charged by the wireless charger 20 using solar energy.

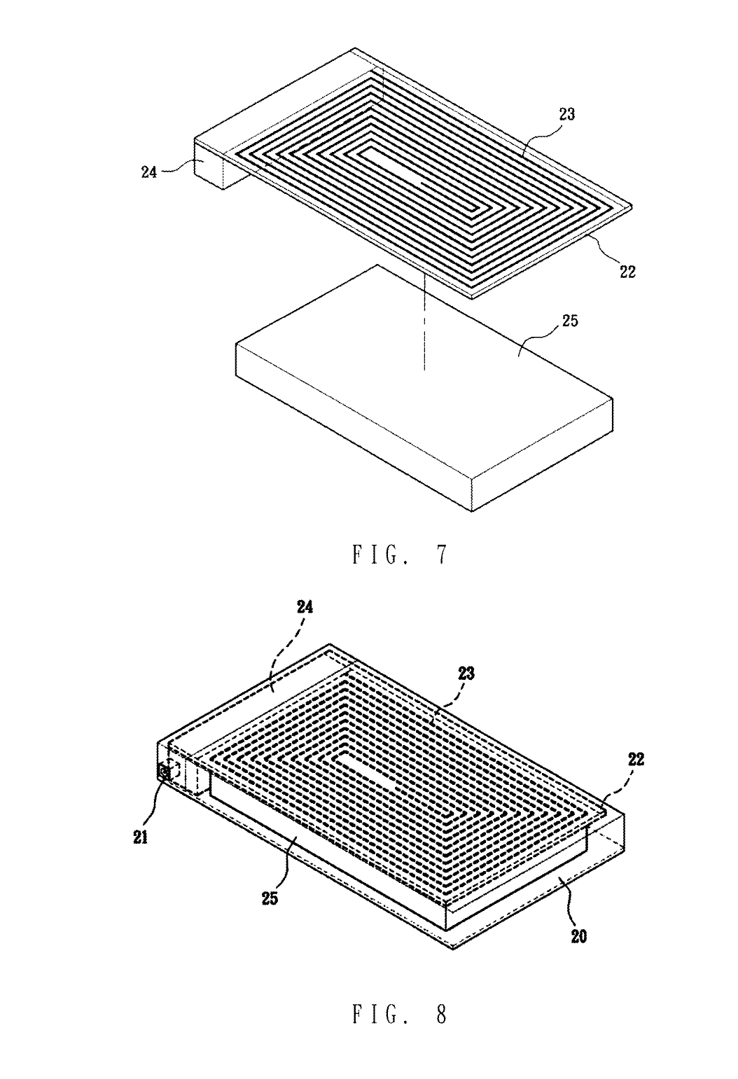

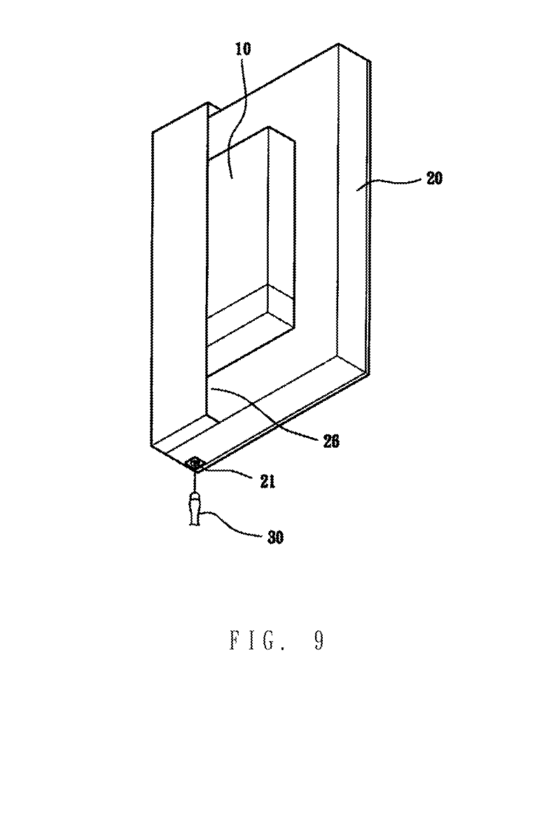

Refer to FIG. 7 and FIG. 8, the wireless charger 20 further includes a rechargeable battery 25 for charging and power storage. The rechargeable battery 25 is electrically connected to the charger board 22. Thus the wireless charger 20 can store the input electricity network power by the rechargeable battery 25.

Refer to FIG. 9, the wireless charger 20 further includes a lateral portion 26 by which the battery module 10 can be arranged at the side surface of the wireless charger 20 while in use.

In summary, electromagnetic induction between the corresponding looped wires of the battery module and of the wireless charger occurs. Thus the power stored in the wireless charger is used to charge the battery of the battery module in a wireless way.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A wireless charging battery module comprising a battery and a charging unit; wherein the charging unit includes a looped wire and a charging circuit; the charging unit is electrically connected to the battery.

2. The device as claimed in claim 1, wherein the wireless charging battery module is disposed with a surface portion that covers both the charging unit and the battery for protection.

3. A charging structure of a wireless charging battery module comprising:
a battery module having a battery and a charging unit; and
a wireless charger having a charger board and the charger board disposed with a looped wire that is corresponding to the looped wire of the charging unit; wherein the charging unit includes a looped wire and a charging circuit while the charging unit is electrically connected to the battery.

4. The structure as claimed in claim , wherein the wireless charger is arranged with a power connector port.

5. The structure as claimed in claim 4, wherein the power connector port is connected to a solar panel.

6. The structure as claimed in claim 3, wherein the wireless charger includes a rechargeable battery for charging and power storage; the rechargeable battery is electrically connected to the charger board.

7. The structure as claimed in claim 3, wherein the wireless charger is arranged with a lateral portion.
